(19) United States
(12) Patent Application Publication
(10) Pub. No.: US 2010/0330841 A1
(43) Pub. Date: Dec. 30, 2010

(54) CABLE CONNECTOR FOR TERMINATING DIFFERENT TYPES OF CABLES

(75) Inventors: XUE-LIANG ZHANG, Kunshan (CN); QING-MAN ZHU, Kunshan (CN); CHIEN-CHIUNG WANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/822,202

(22) Filed: Jun. 24, 2010

(30) Foreign Application Priority Data
Jun. 24, 2009 (CN) 200920304924.5

(51) Int. Cl. H01R 13/648; H01R 13/40

(52) U.S. Cl. 439/607.41; 439/625

(57) ABSTRACT

A cable connector assembly (100) comprises a body (10) defining a mounting hole (13) of a first diameter, an adapter (40) defining a through hole of a second diameter smaller than the first diameter, the adapter being separably mounted to the body, and a cable (120) received in the through hole.

### BACKGROUND OF THE INVENTION

1. Field of the Invention

The present invention relates to a cable connector, and more particularly to a cable connector capable of mating with different types of cables.

2. Description of Related Arts

U.S. Pat. No. 7,056,156, issued to Hanley et al. on Jun. 6, 2006 and entitled with “Vertically offset EMI projections”, discloses a related art. According to the disclosure, a cable assembly comprises a connector and a cable connecting with the connector. The connector comprises a body defining a mounting hole for receiving the cable. The cable assembly further comprises a retention member mounted on the front portion of the cable for retaining the cable on the body of the connector.

The mounting hole of the body has a certain diameter. If another type of cable having a diameter smaller than the certain diameter is to be connected with the cable connector, a gap will be formed between the small diameter type of cable and the mounting hole. The dust may enter into the cable connector through the gap and affect electrical connection. Therefore, it is necessary to manufacture a new body having a mounting hole of a new or smaller diameter comparable to the diameter of the cable employed. However, there will be more cost to manufacture a new body.

Hence, an improved cable connector is required to overcome the above-mentioned disadvantages of the related art.

### SUMMARY OF THE INVENTION

An object of the present invention is to provide a cable connector connecting with different types of cables having different diameters.

To achieve the above-mentioned object, a cable connector assembly comprises a body defining a mounting hole of a first diameter, an adapter defining a through hole of a second diameter smaller than the first diameter, the adapter being separably mounted to the body, and a cable received in the through hole.

According to one aspect of the present invention, the adapter is disposed between the mounting hole of the connector body and the of a smaller size cable. The gap between the mounting hole and the second type of cable is sealed by the adapter. Therefore, it is unnecessary to manufacture a new body having a diameter comparable with the second diameter. The cost of manufacturing an adapter is lower than manufacturing a new body.

### BRIEF DESCRIPTION OF THE DRAWING

FIG. 1 is an assembled perspective view of a cable connector connected with a cable in accordance with the present invention;

FIG. 2 is an assembled perspective view of a portion of the cable connector connected with the cable as shown in FIG. 1 with a body and a retention member being removed;

FIG. 3 is a top view of the cable connector connected with the cable as shown in FIG. 1 with the first body being removed;

FIG. 4 is a perspective view of an adapter of the cable connector as shown in FIG. 1; and

FIG. 5 is a cross-sectional view of the cable connector connected with the cable taken along line 5-5 of FIG. 1.

### DETAILED DESCRIPTION OF THE PREFERRED EMBODIMENT

Reference will now be made in detail to a preferred embodiment of the present invention.

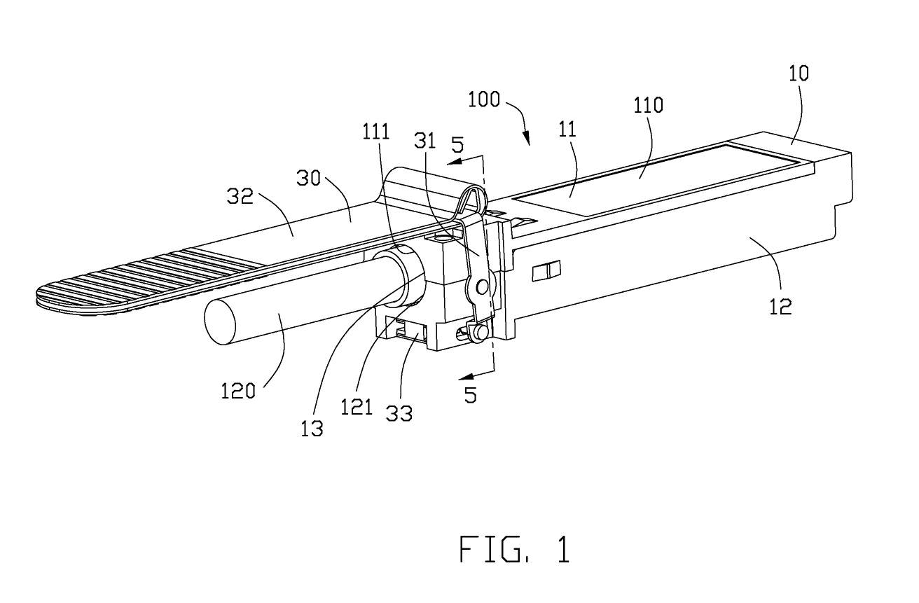

Referring to FIG. 1, a cable assembly 100 made in accordance with a preferred embodiment of the present invention comprises a cable connector or plug connector 110 adapted for connecting with different types of cables 120 having different diameters.

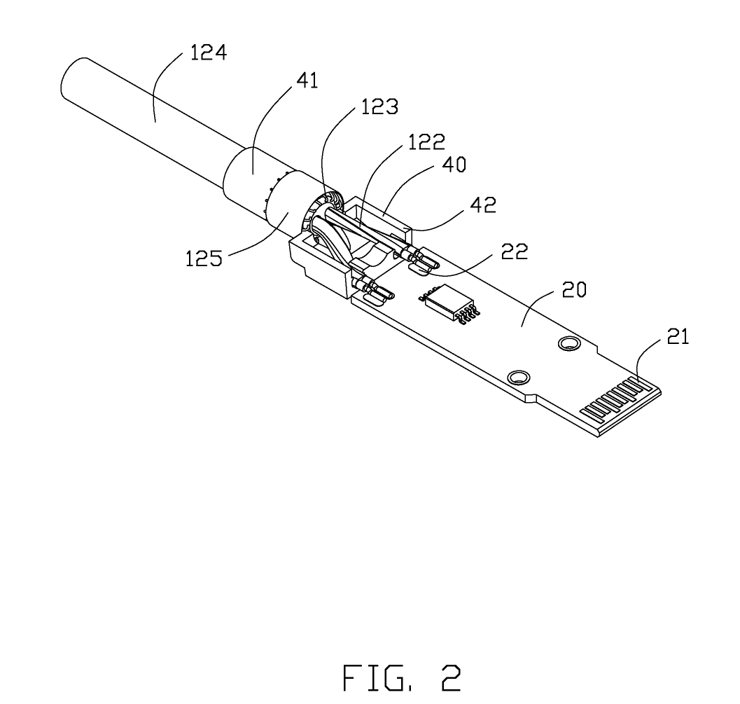

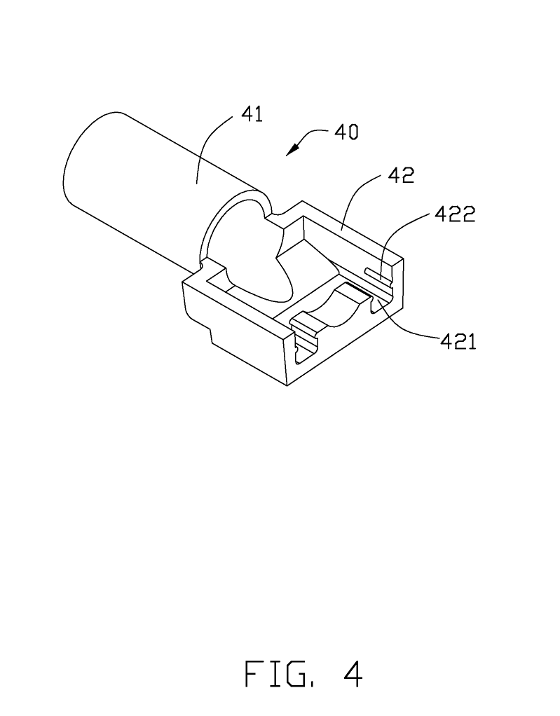

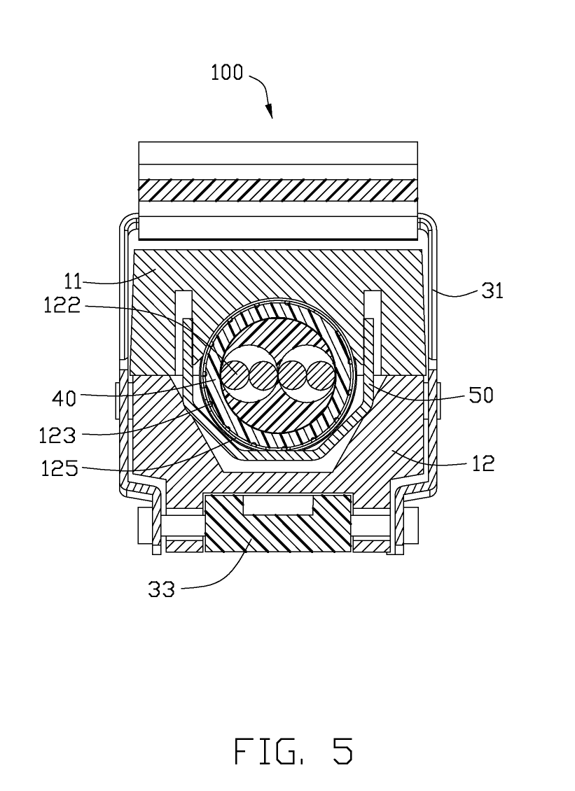

Referring to FIGS. 2-5, the cable connector 110 comprises a body 10, a PCB 20 received in the body 10, a de-latch mechanism 30 mounted on the body 10, and an adapter 40 mounted between the cable connector 110 and the cable 120.

Referring to FIGS. 2-5, the different types of cables may include a first type of cable (not shown) having a first diameter, a second type of cable 120 having a second diameter smaller than the first diameter, or other types of cable having other diameters smaller than the first diameter. Each of the different types of cables may have a number of wires 122, a shielding layer 123 enclosing the wires 122, and a jacket 124 enclosing the shielding layer 123.

Referring to FIGS. 1, 3 and 5, the body 10 comprises a first body 11 and a second body 12 mated with the first body 11. The first body 11 defines a first receiving portion 111, and the second body 12 defines a second receiving portion 121. The first receiving portion 111 and second receiving portion cooperate to define a mounting hole 13, when the first body 11 mates with the second body 12. The mounting hole 13 has the first diameter. The first body 11 connects with the second body 12 by a pair of bolts (not shown).

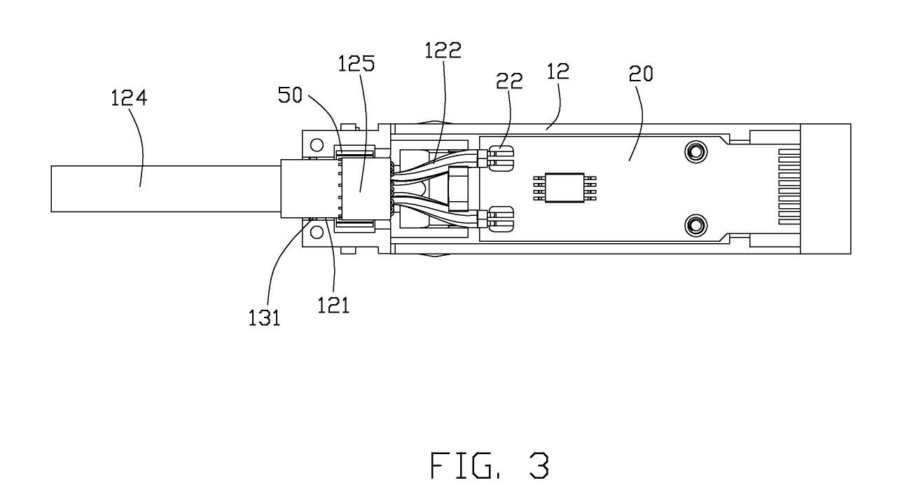

Referring to FIGS. 2 and 3, the PCB 20 is received in the body 10. The PCB 20 comprises a plurality of first conductive pads 21 formed on one end of the PCB 20 for electrically connecting with the mating connector (not shown), and a number of second conductive pads 22 formed on the opposite end of the PCB 20 for electrically connecting with the cable 120.

Referring to FIG. 1, the de-latch mechanism 30 comprises a rotational member 31 pivotably mounted on the body 10, an actuator 32 connecting with one end of the rotational member 31, and a sliding member 33 connecting with the opposite end of the rotational member 31. The rotational member 31 can drive the sliding member 33 to slide along the surface of the body 10, when the actuator 32 is actuated.

Referring to FIGS. 2-5, the adapter 40 comprises a tubular portion 41 and a holding portion 42 connecting with the tubular portion 41. The holding portion 42 defines a number of concavities 421. The tubular portion 41 defines a through hole having the second diameter for receiving the second type of cable 120 or having the other diameters for receiving the other types of cable.

Referring to FIGS. 1-5, the first type of cable and the mounting hole 13 having the same first diameter. Thereby, it is unnecessary to mount the adapter 40 when the first type of cable is connected to the cable connector 110. The second type of cable 120 has a second diameter smaller than the first diameter. Thereby, it is necessary to mount an adapter 40 having a second diameter between the second type of cable 120 and the cable connector 110 when the second type of the cable 120 is connected with the cable connector 110. The other types of cable have other diameters smaller than the first diameter. Thereby, it is necessary to mount an adapter 40 having other diameters between the other types of cable and the cable connector 110. The cost of manufacture different types of adapter having different diameters of through hole is lower than the cost of manufacture different types of body 10 having different diameters of mounting hole 13.

Referring to FIGS. 1 to 5, as the cable 120 is connected with the cable connector 110, a portion of one end of the second type of cable 120 is inserted through the through hole of the tubular portion 41 of the adapter 40. A portion of the shielding layer 123 of the end of the second type of cable 120 is overlapped on the tubular portion 41. The portion of the shielding layer 123 is enclosed by a conductive layer 125. Thereby, the shielding layer 123 is electrically connected to the body 10 through the conductive layer 125. The adapter 40 and the end of the second type of cable 120 are received in the body 10. The tubular portion 41 is received in the mounting hole 13. A retention member 50 is mounted on the second receiving portion 121 of the second body 12 for securely retaining the tubular portion 41 in the second receiving portion 121.

Referring to FIGS. 2-5, the wires 122 are fixed on the holding portion 42 of the adapter 40. The concavities 421 have a plurality of ribs 422 for interference fitting with the wires 122. The wires 122 extend beyond the holding portion 42 to solder on the second conductive pads 22 of the PCB 20. The mounting hole 13 has a projection 131 for interference fitting with the tubular portion 41 of the adapter 40 to auxiliary clip the second type of cable 120.

The cable connector 110 include an adapter 40. Therefore, it is unnecessary to manufacture different types of body 10 having different diameters of the mounting hole 13, when the cable connector 110 connects to different types of cable having different diameters. The gap between the second type of cable 120 and the mounting hole 13 is sealed by the adapter 40. Therefore, dust is prevented from entering into the cable connector 110. The shielding layer 123 of the second cable 120 is sufficiently electrically connected with the body 10. Therefore, the anti-EMI function of the cable assembly 100 is improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly comprising:
a body defining a mounting hole of a first diameter;
an adapter defining a through hole of a second diameter smaller than the first diameter, the adapter being separably mounted to the body; and
a cable received in the through hole.

2. The cable connector assembly as recited in claim 1, wherein said adapter comprises a tubular portion, the through hole defined on the tubular portion.

3. The cable connector assembly as recited in claim 2, wherein said cable comprises a plurality of wires, said adapter comprising a holding portion connected with the tubular portion and retaining the wires.

4. The cable connector assembly as recited in claim 3, wherein said holding portion defines a plurality of concavities for receiving the wires.

5. The cable connector assembly as recited in claim 4, wherein each of the concavities defines a plurality of ribs interference fitting with corresponding wires respectively.

6. The cable connector assembly as recited in claim 3, further comprising a PCB received in the body, the wires being soldered on the PCB.

7. The cable connector assembly as recited in claim 1, wherein said body comprises a first body defining a first receiving portion and a second body defining a second receiving portion, the first receiving portion and the second receiving portion cooperating to define the mounting hole.

8. The cable connector assembly as recited in claim 1, wherein said mounting hole defines a projection interference fitting with the adapter.

9. The cable connector assembly as recited in claim 1, further comprising a conductive layer, and wherein said cable comprises a shielding layer enclosing the wires and a jacket enclosing the shielding layer, a part of the shielding layer being overlapped on the adapter, the conductive layer enclosing the part of the shielding layer for electrically connecting with the body and the shielding layer.

10. The cable connector assembly as recited in claim 9, further comprising a retention member mounted on the mounting hole, the retention member and the body cooperating to clip the adapter.

11. An electrical cable connector comprising:
a case body defining at a rear end a mounting through hole of essentially a first inner diameter thereof;
an adaptor discrete from the case body and assembled to the rear end of the case body, said adaptor including a circular tubular portion which is received in the mounting through hole and defines thereof a through hole of a second inner diameter smaller than the first inner diameter; and
a round cable extending through the through hole.

12. The electrical cable connector as claimed in claim 11, wherein said adaptor is detachable from the case body.

13. The electrical cable connector as claimed in claim 11, wherein said adaptor further includes a holding portion linked to and in front of the tubular portion and dimensioned larger than the first inner diameter.

14. The electrical cable connector as claimed in claim 13, wherein the holding portion defines a plurality of concavities to receive corresponding inner wires of the cable.

15. The electrical cable connector as claimed in claim 13, wherein said holding portion defines a rectangular configuration.

16. The electrical cable connector as claimed in claim 11, wherein a conductive sleeve encloses the tubular portion with a shielding layer of the cable sandwiched therebetween radially.

17. The electrical cable connector as claimed in claim 11, wherein circumstantially a portion of the tubular portion abuts against the case body, and another portion of the tubular portion is pressed by a metallic retention member.

18. The electrical cable connector as claimed in claim 17, wherein said retention member is essentially of a U-shaped configuration.

19. The electrical cable connector as claimed in claim 17, wherein said another portion of the tubular portion is indirectly pressed by the metallic retention member via a conductive sleeve which encloses the tubular portion with a shielding layer of the cable sandwiched therebetween radially.
